(19) United States
(12) Patent Application Publication
(10) Pub. No.: US 2014/0176866 A1
(43) Pub. Date: Jun. 26, 2014

(54) LED DEVICE AND LIQUID CRYSTAL DISPLAY DEVICE

(71) Applicant: HON HAI PRECISION INDUSTRY CO., LTD., New Taipei (TW)

(72) Inventor: Yung-Chang TSENG, New Taipei (TW)

(21) Appl. No.: 13/923,198

(22) Filed: Jun. 20, 2013

(30) Foreign Application Priority Data
Dec. 21, 2012 (TW) 101148888

(51) Int. Cl. G02F 1/1335

(52) U.S. Cl. CPC G02F 1/133606
USPC 349/64; 257/98

(57) ABSTRACT

An LED device includes an LED chip, a fluorescent layer and a lens. The fluorescent layer has phosphor powder diffused therein. The lens covers the LED chip and is positioned between the LED chip and the fluorescent layer. Light emitting from the LED chip travels through the lens and the fluorescent layer to obtain white light. The present discloser also provides a liquid crystal display using the LED device described above.

### BACKGROUND

1. Technical Field

The disclosure relates to LED (light emitting diode) devices, and particularly to an LED device and a liquid crystal display using the same.

2. Description of the Related Art

An LED device for a back light module typically includes a plurality of blue LED chips and a yellow fluorescent layer covering the blue LED chips. A portion of blue light emitted from the blue LED chips is converted into yellow light by the yellow fluorescent layer, then, the yellow light and the other portion of the blue light emitted from the blue LED chips are combined to obtain white light.

The LED chip usually has a light output angle about 120°, which has an uneven distribution of light field with high light intensity at center thereof and low light intensity at periphery thereof. Therefore, a lens is always applied to cover the fluorescent layer to increase the light output angle and distribute the light evenly at center and at periphery thereof. However, a yellow ring is always generated when the white light travels through the lens. The yellow ring will result in chromatism when the LED chips are used as a backlight source in a liquid crystal display.

Therefore, it is desirable to provide an LED device and a liquid crystal display using the same which can overcome the above shortcomings.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present LED device and a liquid crystal display using the same. Moreover, in the drawings, like reference numerals designate corresponding parts throughout the views.

FIG. 1 is a schematic, cross-sectional view of an LED device in accordance with an embodiment of the present disclosure.

FIG. 2 is a schematic, cross-sectional view of a liquid crystal display using the LED device shown in FIG. 1.

### DETAILED DESCRIPTION

Reference will now be made to the drawings to describe the present LED device, and a liquid crystal display using the LED device, in detail.

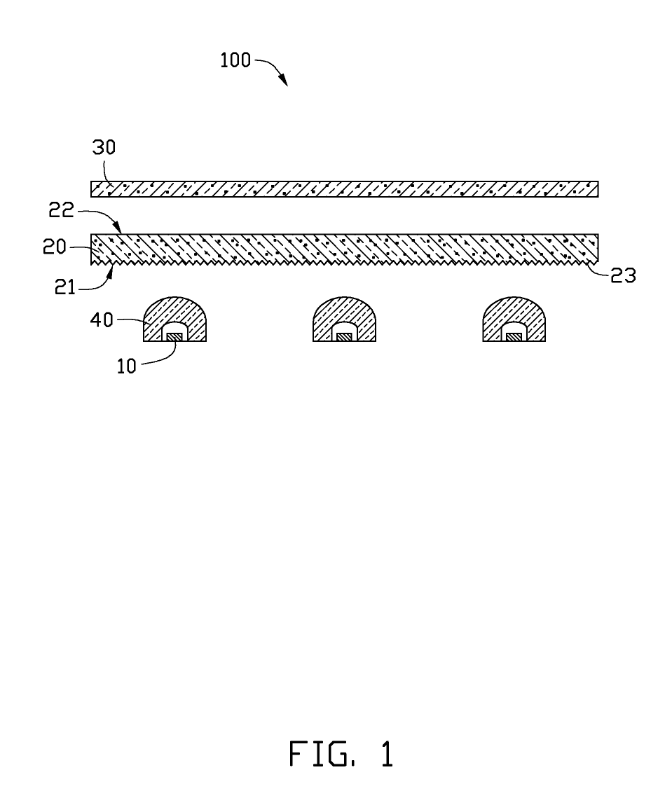

Referring to FIG. 1, an LED device 100 includes a plurality of LED chips 10, a diffuser plate 20, a fluorescent layer 30 and a plurality of lenses 40.

The LED chips 10 can be blue chips or near-ultraviolet chips. Each lens 40 covers an LED chip 10. Light emitting from the LED chip 10 travels through the lens 40 and is deflected by the lens 40 to diffuse with a single wavelength. The diffused light has an angle larger than 120 degrees. As such, light intensity between neighboring LED chips 10 are enhanced, thereby a distance between neighboring LED chips 10 can be increased and less LED chips 10 are required.

The diffuser plate 20 is positioned between the lenses 40 and the fluorescent layer 30. The light emitting from the LED chips 10 travels through the lens 40, the diffuser plate 20 and the fluorescent layer 30 in sequence. The diffuser plate 20 is made of transparent organic resin, such as Polymethyl Methacrylate (PMMA) or Polycarbonate (PC). Light scattering particles are diffused in the diffuser plate 20 to further distribute the light striking into the diffuser plate 20 evenly. The diffuser plate 20 is substantially a plate in shape. The diffuser plate 20 includes a light inputting surface 21 and a light outputting surface 22. The light inputting surface 21 is a non-flat surface with a plurality of micro-structures 23 formed thereon. The light emitting from the LED chip 10 enters the diffuser plate 20 through the light inputting surface 21. The light strikes on the light inputting surface 21 and is reflected/refracted to be distributed evenly by the light scattering particles when traveling in the diffuser plate 20.

The fluorescent layer 30 has phosphor powder evenly dropped therein.

In this embodiment, the LED chips 10 can be blue chips and the fluorescent layer 30 can include yellow phosphor powder. Alternatively, the LED chips 10 can be blue chips and the fluorescent layer 30 can include red phosphor powder and green phosphor powder. The LED chips 10 can also be near-ultraviolet chips and the fluorescent layer 30 can include red phosphor powder, blue phosphor powder and green phosphor powder. The near-ultraviolet chips emit near-ultraviolet light with a wavelength between 200 nanometers and 380 nanometers.

In the embodiment, neighbor LED chips 10 are arranged in equal space. Each LED chip 10 has a similar light output angle and light intensity to adjacent LED chips 10. Blue light emitting from each LED chip 10 strikes into the lens 40 and forms blue light, and then the blue light strikes into the diffuser plate 20. Blue light is distributed evenly in the diffuser plate 20 because the light scattering particles are diffused in the diffuser plate 20 evenly. Then even blue light emits out of the light outputting surface 22 of the diffuser plate 20 and strikes into the fluorescent layer 30. The blue light strikes on the yellow phosphor powder of the fluorescent layer 30 to form even yellow light. The even yellow light and the even blue light are mixed together, obtaining even white light.

In the present disclosure, the lens 40 directly covers the single light LED chip 10 to obtain diverging blue light. The blue light strikes into the diffuser plate 20 and is further diverged. Finally, the even blue light travels through the fluorescent layer 30 and obtain even white light. A yellow ring is thus avoided since mixture of the yellow light and the blue light is later than diffusion of the blue light.

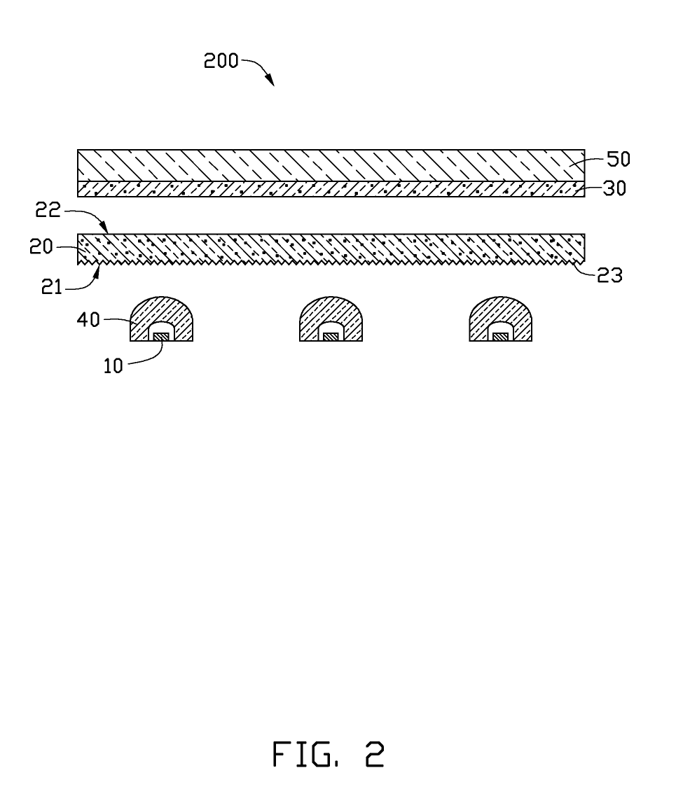

Referring to FIG. 2, the LED device 100 is used as a backlight source in a liquid crystal display 200. The liquid crystal display 200 includes a liquid crystal module 50 and the LED device 100 described above. The liquid crystal module 50 is positioned on the fluorescent layer 30 away from the lens 40.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An LED device, comprising:
an LED chip;
a fluorescent layer with phosphor powder diffused therein; and
a lens covering the LED chip and positioned between the LED chip and the fluorescent layer, and light emitting from the LED chip traveling through the lens and the fluorescent layer to obtain white light.

2. The LED device of claim 1 further comprising a diffuser plate, wherein the LED chip and the fluorescent layer are positioned at two opposite sides of the diffuser plate, and the light emitting from the LED chip travels through the lens, the diffuser plate and the fluorescent layer in sequence.

3. The LED device of claim 2, wherein the diffuser plate comprises light scattering particles.

4. The LED device of claim 2, wherein the diffuser plate comprises a light inputting surface and a light outputting surface away from the light inputting surface.

5. The LED device of claim 2, wherein a plurality of micro-structures are formed on the light inputting surface.

6. The LED device of claim 1, wherein the LED chip is a chip emitting blue light, and the fluorescent layer comprises yellow phosphor powder.

7. The LED device of claim 1, wherein the LED chip is chip emitting blue light, and the fluorescent layer comprises red phosphor powder and green phosphor powder.

8. The LED device of claim 1, wherein the LED chip is a chip emitting near-ultraviolet light, and the fluorescent layer comprises red phosphor powder, blue phosphor powder and green phosphor powder.

9. The LED device of claim 8, wherein the near-ultraviolet chip emits the near-ultraviolet light with a wavelength between 200 nanometers and 380 nanometers.

10. A liquid crystal display, comprising:
a liquid crystal module; and
an LED device, comprising:
an LED chip;
a fluorescent layer with phosphor powder diffused therein; and
a lens covering the LED chip and positioned between the LED chip and the fluorescent layer, light emitting from the LED chip traveling through the lens and the fluorescent layer to obtain white light, and the liquid crystal module positioned on the fluorescent layer away from the lens.

11. The liquid crystal display of claim 10 further comprising a diffuser plate, wherein the LED chip and the fluorescent layer are positioned at two opposite sides of the diffuser plate, and the light emitting from the LED chip travels through the lens, the diffuser plate and the fluorescent layer in sequence.

12. The liquid crystal display of claim 11, wherein the diffuser plate comprises light scattering particles.

13. The liquid crystal display of claim 11, wherein the diffuser plate comprises a light inputting surface and a light outputting surface away from the light inputting surface.

14. The liquid crystal display of claim 11, wherein a plurality of micro-structures are formed on the light inputting surface.

15. The liquid crystal display of claim 10, wherein the LED chip is a chip emitting blue light, and the fluorescent layer comprises yellow phosphor powder.
